(19) United States
(12) Patent Application Publication
(10) Pub. No.: US 2026/0343319 A1
(43) Pub. Date: Oct. 29, 2026

(54) TECHNOLOGIES FOR CONGESTION INDICATIONS IN EXTENDED REALITY SIGNALING

(71) Applicant: Apple Inc., Cupertino, CA (US)

(72) Inventors: Ralf Rossbach, Munich (DE); Fangli Xu, Beijing (CN); Ping-Heng Kuo, London (GB)

(73) Assignee: Apple Inc., Cupertino, CA (US)

(21) Appl. No.: 19/111,761

(22) PCT Filed: Sep. 30, 2022
(86) PCT No.: PCT/CN2022/123167

§ 371 Date: Mar. 13, 2025

(30) Foreign Application Priority Data
Sep. 23, 2022 (WO) PCT/CN2022/121066

(51) Int. Cl. H04W 28/02; H04L 43/087; H04L 67/131

(52) U.S. Cl. CPC H04W 28/0284; H04L 43/087; H04L 67/131; H04W 28/0252; H04W 28/0289

(57) ABSTRACT

The present application relates to devices and components including apparatus, systems, and methods for congestion indications in extended reality signaling.

### TECHNICAL FIELD

This application relates generally to communication networks and, in particular, to technologies for congestion detection in such networks.

### BACKGROUND

Low latency low loss scale throughput (L4S) is a technology based on an Internet Engineering Task Force (IETF) standardization. L4S provides high throughput and low latency for Internet protocol (IP) traffic that may result in improved, fast-radio adaption management and reduce network congestion, queuing, and packet loss.

### BRIEF DESCRIPTION OF THE DRAWINGS

FIG. 1 illustrates a network environment in accordance with some embodiments.

FIG. 2 illustrates data bursts in accordance with some embodiments.

FIG. 3 illustrates transmission and reception of PDU sets in accordance with some embodiments.

FIG. 4 illustrates an operation flow/algorithmic structure in accordance with some embodiments.

FIG. 5 illustrates another operation flow/algorithmic structure in accordance with some embodiments.

FIG. 6 illustrates another operation flow/algorithmic structure in accordance with some embodiments.

FIG. 7 illustrates an user equipment in accordance with some embodiments.

FIG. 8 illustrates a network node in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth, such as particular structures, architectures, interfaces, and/or techniques in order to provide a thorough understanding of the various aspects of some embodiments. However, it will be apparent to those skilled in the art having the benefit of the present disclosure that the various aspects of the various aspects may be practiced in other examples that depart from these specific details. In certain instances, descriptions of well-known devices, circuits, and methods are omitted so as not to obscure the description of the various aspects with unnecessary detail. For the purposes of the present document, the phrase “A or B” means (A), (B), or (A and B); and the phrase “based on A” means “based at least in part on A,” for example, it could be “based solely on A” or it could be “based in part on A.”

The following is a glossary of terms that may be used in this disclosure.

The term “circuitry” as used herein refers to, is part of, or includes hardware components, such as an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), and/or digital signal processors (DSPs), that are configured to provide the described functionality. In some aspects, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these aspects, the combination of hardware elements and program code may be referred to as a particular type of circuitry.

The term “processor circuitry” as used herein refers to, is part of, or includes circuitry capable of sequentially and automatically carrying out a sequence of arithmetic or logical operations; or recording, storing, or transferring digital data. The term “processor circuitry” may refer an application processor; baseband processor; a central processing unit (CPU); a graphics processing unit; a single-core processor; a dual-core processor; a triple-core processor; a quad-core processor; or any other device capable of executing or otherwise operating computer-executable instructions, such as program code; software modules; or functional processes.

The term “interface circuitry” as used herein refers to, is part of, or includes circuitry that enables the exchange of information between two or more components or devices. The term “interface circuitry” may refer to one or more hardware interfaces; for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “computer system” as used herein refers to any type of interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to computer, storage, or network resources provided by physical hardware element(s). A “virtualized resource” may refer to computer, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, virtualized network function, or the like.

The term “information element” refers to a structural element containing one or more fields. The term “field” refers to individual contents of an information element or a data element that contains content. An information element may include one or more additional information elements.

Current L4S technology relies on an explicit congestion notification (ECN) in an IP header to indicate queue buildup in intermediate routers or radio links. Upon ECN reception, congestion signals may be propagated back to a sender. The signals may be sent via a transmission control protocol (TCP) ECN-echo that trigger scalable congestion control algorithms. A TCP congestion window reduced (CWR) bit may be sent back to acknowledge to the receiver that the congestion-indication echoing was received. Similar signaling may be supported on other layer 4 (L4) protocols such as QUIC.

When congestion is detected, the application server or application may adjust the application bit rate to meet capacity of the established communication link. As a result, L4S may deliver a seamless user experience even with variable traffic load and radio conditions.

Changing the ECN bits in an IP header as a queue starts to grow to signal congestion may be referred to as marking. ECN/L4S use two least significant bits of a traffic class field in an IPv4 or IPv6 header to encode four different code points. In ECN, a congestion mark is equivalent to a packet drop. In L4S, a congestion mark serves as an indication instead of dropping the packet.

L4S allows relatively fine granular congestion control depending on the application (for example, with active queue management (AQM) and scalable TCP). L4S allows for improved queue utilization and better use of network resources. If applied to the radio, it may allow for better spectrum utilization. Routers or nodes using AQM may signal EC and immediately upon detecting high delay or high buffer status.

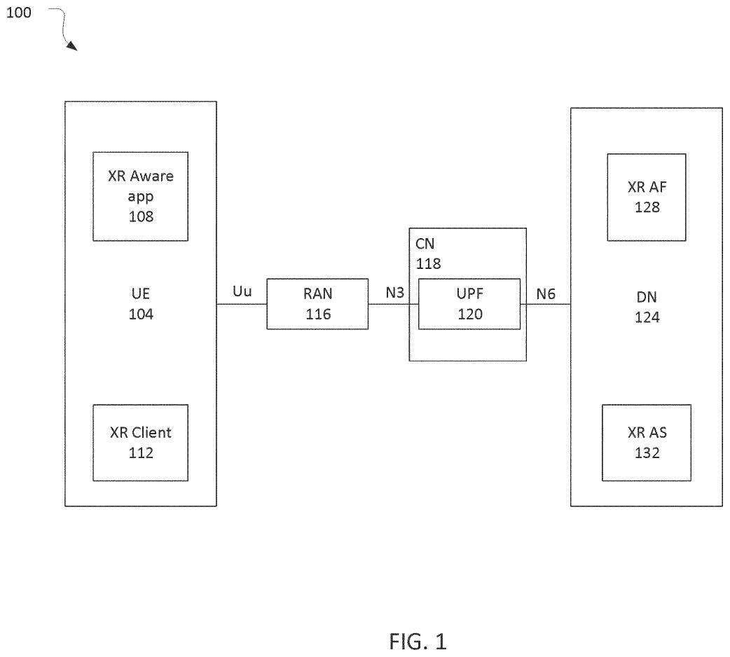

FIG. 1 illustrates a network environment 100 in accordance with some embodiments. The network environment 100 may provide for extended reality (XR) services.

Briefly, the network environment 100 may include a user equipment (UE) 104 having an XR aware application 108 and an XR client 112. The XR aware application 108, which may also be referred to as a XR application 108, may be a source or destination of XR traffic related to XR services. The XR client 112 may be an internal function of the UE 104 that is dedicated to XR services.

The UE 104 may be coupled with a radio access network (RAN) 116 via a Uu interface. The RAN 116 may include one or more base stations (for example, gNBs), integrated access and backhaul (IAB) nodes, etc. that provide the UE 104 with radio access to a core network (CN) 118.

The RAN 116 may be coupled with a user plane function (UPF) 120 of the CN 118 via an N3 interface. The UPF 120 may be responsible for routing and forwarding user-plane packets between the RAN 116 and one or more data networks (DNs). The UPF 120 may handle the user plane path of protocol data unit (PDU) sessions.

As shown, the UPF 120 may be coupled with a DN 124 via an N6 interface. The DN 124 may be a trusted DN or an external DN that includes an XR application function (AF) 128 and an XR application server (AS) 132 that are dedicated to XR services.

The components of the network environment may operate in a manner compatible with Fifth Generation (5G) or later networks. For example, unless otherwise described herein, aspects of the network environment 100 may be compatible with XR use cases and media services similar to that described in 3GPP Technical Report (TR) 26.928, v17.0.0 (2022 Apr. 7).

XR services supported by the network environment 100 may require deterministic behavior with a defined quality of service (QoS). This may involve multiple streams with different QoS requirements. The payload may often be periodical.

In some embodiments, the XR aware application 108 may operate on application data units (ADUs) (e.g., PDU sets) or data bursts represented by larger chunks of data where each “chunk” of application layer data includes a series of IP packets. Such application layer data may be delivered in a burst (often relatively periodical). A burst can include a set of ADUs, where each ADU is transmitted in a number of smaller data packets (such as real-time transport protocol (RTP) packets mapped to packet data convergence protocol (PDCP) service data units (SDUs)).

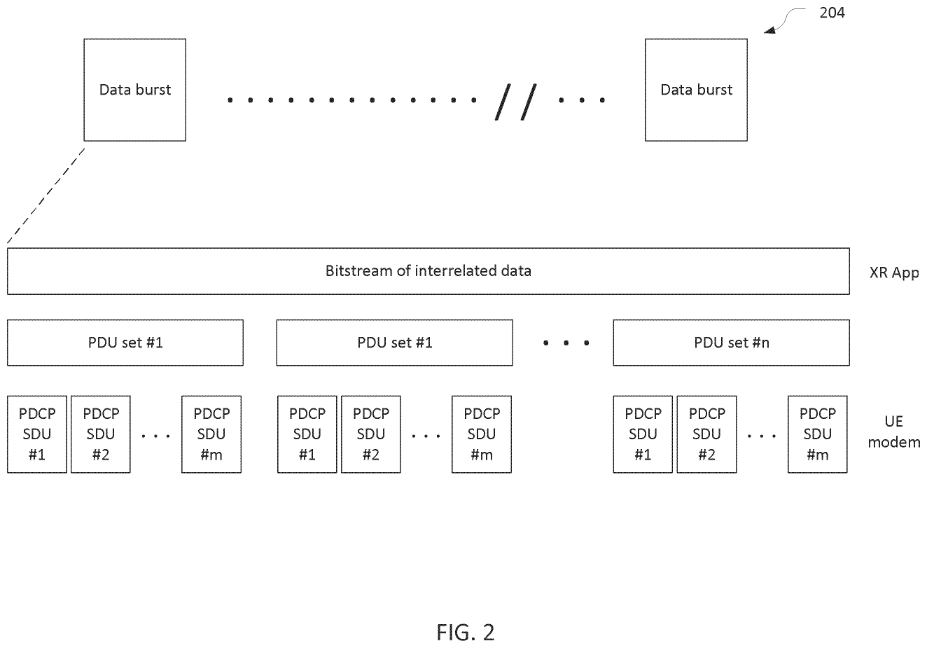

FIG. 2 illustrates data bursts 204 that the XR aware application 108 may transmit or receive. The data bursts may be a bit stream of interrelated application data. The data may correspond to an application such as, for example, an XR application. The bitstream may be divided into a plurality of PDU sets, which may be equivalent to an ADU in the context of XR. One PDU set may be transmitted in a number of smaller data packets, for example, RTP packets mapped to PDCP SDUs. While FIG. 2 shows each PDU set having m PDCP SDUs, different PDU sets may have different numbers of PDCP SDUs.

As mentioned above, ECN/L4S is an end-to-end mechanism that depends on the capability of the transport network. It may enable faster codec rate adaptation at the end-points and may help to keep the latency low and the throughput high.

From a radio interface perspective, it may be of interest to convey whether or not congestion exists at the radio layers or even within the 5G system. Especially at the air interface, mostly only one bit is sufficient. The bit can be expressed as a congestion experienced (CE) bit that is communicated to upper layers and translated into the respective representation at the IP layer. ECN, L4S, and CE are used interchangeably herein.

The support of XR services may benefit from low latency and high throughput. Enabling the network environment 100 for XR-aware congestion signaling may help to reduce latency, keep the throughput stable, and provide desired user experience.

Some embodiments address situations in which QoS is driven by groups of packets rather than individual packets. In particular, embodiments describe how congestion indications can be utilized (and signaled) for PDU sets such as those shown in FIG. 2. Embodiments also describe how congestion indications can be used to trigger adjustments to the treatment of XR traffic flows and PDU sets.

The disclosure describes methods for the network (for example, RAN 116 or UPF 120) or the UE 104 to utilize awareness of CE indications for processing of PDU sets in XR. Aspects include CE marking of PDU sets and packets in a PDU set, actions to mitigate congestion, and application to XR traffic.

To accommodate XR traffic, the CN 118, the RAN 116, and the UE 104 may benefit from being able to identify: the different PDU sets (for example, distinguish between them); the PDUs that belong to each PDU set; the dependencies between PDUs sets; and the dependencies for PDUs within a PDU set. Being able to identify these features may potentially lead to the introduction of additional L2 headers, with new types of fields for identification of PDU sets and the PDUs therein.

Embodiments describe enhancements on CE indications for the UE 104, the RAN 116, and CN 118 when PDU sets are supported.

A PDU set that has already experienced congestion in the CN 118 or in the RAN 116 may be treated differently than a PDU set that has not experienced congestion. Congestion information may be visible from the CE bits at radio interfaces in the UE 104, RAN 116, or CN 118.

The detection and indication of congestion related information for a PDU set may happen through various L2 sublayers and communicated to upper layers. For example, congestions may be detected/indicated based on PDCP/service data adaptation protocol (SDAP) layer (using separate queue), through radio link control (RLC) layer, or through media access control (MAC) layer. Alternatively, a PDU set may carry a CE indication itself.

In general, detection of a congestion event may occur by comparing operating states to various predetermined thresholds. The operating states may be associated with a state of a queue or buffer (e.g., percent filled, amount of data, etc.), a number of retransmissions, a number of acknowledgements, whether a packet was determined to be successfully transmitted with a period of time (e.g., based on a delay budget or discard timer), receipt or transmission of a packet within an expected period of time, a sojourn time, a round-trip time, a size of a gap in sequence numbers, quality of service (QoS) parameters, quality of experience (QoE) parameters, etc.

Congestion may be indicated by one or more layers including one or more CE bits in a communicated packet or providing an inter-layer signal. One CE bit may be used to provide a CE-set indication (to indicate congestion is experienced) or a CE-clear indication (to indicate congestion is not experienced).

While many embodiments describe congestion as existing in a binary state, for example, either congestion is present or is not, other embodiments may provide for different levels of congestion being detected/signaled in similar matters.

In some embodiments, two CE bits may be used to allow support of use cases where full end-to-end ECN/L4S consistency might be desired. The two bits may correspond to codepoints according to ECN codepoints shown in Table 1 or L4S codepoints shown in Table 2 below.

TABLE 1

| Binary codepoint | Codepoint name | Meaning |
|---|---|---|
| 00 | Not-ECT | Not ECN-capable transport |
| 01 | ECT(1) | ECN-capable transport |
| 10 | ECT(0) | ECN-capable transport |
| 11 | CE | Congestion experienced |

TABLE 2

| Binary codepoint | Codepoint name | Meaning |
|---|---|---|
| 00 | Not-ECT | Not ECN-capable transport |
| 01 | ECT(1) | L4S-capable transport |
| 10 | ECT(0) | Not L4S capable transport |
| 11 | CE | Congestion experienced |

These codepoints may be similar to those described in IETF RFC 3168.

In some embodiments, upon identification that a PDU set has experienced congestion, the RAN 116 or the UE 104 may alter the treatment of the PDU set. For example, the RAN 116 or the UE 104 may increase a priority level for the PDU set to ensure faster scheduling; consider the PDU set as a PDU set of higher importance; adjust the LCH priority of the DRB or QoS flow associated with the XR traffic flow to a higher priority level; enable PDCP duplication for this PDU set; adjust the radio resource allocation to ensure remaining packets in the PDU set are allocated more reliable resources; allocate additional radio resources for the UE to schedule any remaining next packets immediately; enter survival time (e.g., enter a survival state or mode in which an application needs to receive a data burst within a set period of time in order to maintain connection) until the congestion condition is cleared; inform upper layers of the congestion condition; or inform a subsequent network node of the congestion condition.

In some embodiments, layer 2 configurations such as logical channel (LCH) settings (e.g. logical channel prioritization (LCP) mapping restriction rules) could be changed when a transmitter determines that congestion is being experienced. For example, a PDCP layer may switch between RLC entities with different LCH configurations to process a PDCP PDU. This may be done to select an RLC entity that may provide faster transmission of the underlying XR traffic.

In some embodiments, layer 1 (L1) parameters may be adjusted to facilitate transmission of XR traffic that is experiencing congestion. For example, L1 parameters such as configured grant (CG)/semi persistent scheduling (SPS) configurations, modulation and coding scheme (MCS), number of repetitions, and transmit power could be changed when the transmitter becomes aware that a PDU set has experienced congestion.

Upon detection of congestion for a traffic flow or data burst, the UE 104 or the RAN 116 may adjust treatment of PDU sets based on importance associated with each PDU set. For example, some PDU sets may be deemed to have a relatively greater importance as compared to other PDU sets. Consider, for example, a video compression standard such as H.264 in which video may be transmitted as an intra-coded picture (I) frame, a predicted (P) frame, or a bidirectional predicted (B) frame. The I frames may serve as a reference for the other frames and, therefore, be associated with a higher importance as compared to the B/P frames. Thus, if congestion is detected, some embodiments may prioritize the transmission of more important PDU sets (such as I-frames) over PDU sets of less importance (e.g., P frames). In embodiments in which prioritization is already implemented, detected congestion may be used as a basis to increase the relative prioritization of the more important PDU sets. Additionally/alternatively, when congestion is detected, a transmitter may drop PDU sets of lower importance or apply a congestion policy (with respect to scheduling rules and prioritization) as defined by the network.

In some embodiments, congestion may be indicated though CE fields within packets at various layers of a communication protocol carrying one or more CE bits as described elsewhere herein. The congestion indication may then trigger one or more of the above measures.

In some embodiments, congestion level information may be exposed by the UE 104 or the CN 118 to the RAN 116 in a separate parameter, such as assistance information. The congestion level information may be provided in level steps (e.g., high, medium, or low congestion (or some other demarcation)), or as a percentage of packets or PDU sets that have experienced congestion over a period of time. In some embodiments, exposing the congestion level information may allow for more fine-granular control of scheduling policies or may help to guide any desired retransmission of PDU sets. These functionalities in the UE 104, RAN 116, or CN 118 may be considered XR aware functionalities.

Some embodiments may utilize new packet headers associated with the PDU sets that carry XR traffic for CE indications. The packet headers may be extended to allow for one or more CE bits. This may be based on one or more of the following options.

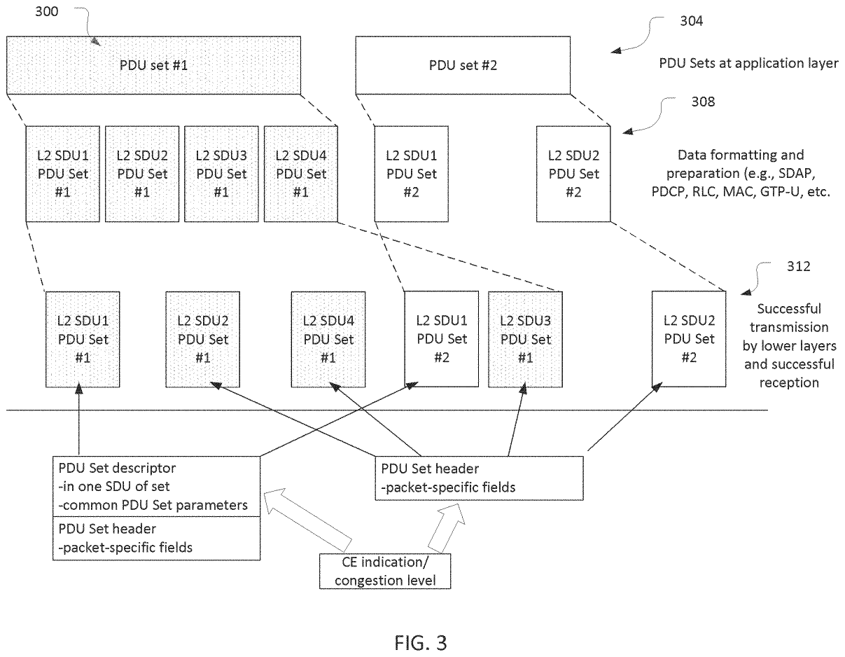

FIG. 3 illustrates transmission and reception of PDU sets in accordance with some embodiments. Two PDU sets may be generated at an application layer at 304, PDU Set #1 and PDU Set #2. The PDU sets may be packetized into lower layer packets (for example, layer 2 (L2) SDUs) based on existing principles of data formatting and preparation at the transmitter.

The L2 SDUs may be transmitted by lower layers of the transmitter at 308 and received by lower layers of the receiver at 312. As shown, the L2 SDUs may be received at 312 in an order different than the order in which they were transmitted.

In some embodiments, the information may be added to the L2 SDUs as PDU set descriptors or PDU set headers. The PDU set descriptor may be the larger header of the two. One packet in every PDU set may carry the PDU set descriptor, which may indicate PDU set parameters that are common to all packets in the PDU set. For example, the PDU set parameters that may be included in the PDU set descriptor may be parameters that describe the PDU set such as an PDU set type or importance. In some embodiments, the PDU set descriptor may be included in only one packet of the PDU set, for example, the first packet. As shown, PDU set descriptors may be present L2 SDU1 PDU Set #1 and L2 SDU1 PDU Set #2.

The PDU set header may include packet-specific fields. For example, the PDU set parameters that may be included in the PDU set header may be parameters that describe a packet's position with respect to the set of packets that convey the PDU set.

In some embodiments, instead of sending the PDU set descriptor in a packet that carries a portion of the PDU set, the UE 104 may send the PDU Set descriptor using a semi-static indication through, for example, access stratum (AS) scheduling assistance information or a non-access stratum (NAS) message.

CE indications or congestion level information may be added to the headers (for example, the PDU set descriptor or the PDU Set header) of the L2 SDUs in accordance with one or more of the options described below.

In a first option, a CE indication may be carried as a single congestion marking for the whole PDU set. For example, the CE indication may be included in the PDU set descriptor for the PDU set or in a semi-static indication used to identify other common characteristics of the PDU set (such as PDU set size, delay budget, error rate, etc.). As the congestion marking is present only once, the remaining PDUs of the PDU set do not need to carry a CE marking. Upon detection of the CE marking, when required by upper layers or when configured by the network, the receiver may mark every packet in the PDU set with a CE indication, based on the common marking for the PDU set. Alternatively, the receiver may just forward the marking for the PDU set to the next node.

In a second option, the CE indication may be provided in the PDU set header so that it is carried in every packet of the PDU set. Even though congestion is indicated on a per packet basis, the evaluation and detection of congestion may happen for the PDU set as a whole. Different PDU sets may enter a state of congestion at different times, for example, different sojourn times or different buffer residency times may apply. This may be based on configuration or characteristics. Providing the CE indication in the PDU set header provides the flexibility to mark a subset of packets in the PDU set or all the packets in the PDU set with the CE indication. In some embodiments, even if congestion is only marked for a subset of the packets in a PDU set, congestion may be identified very quickly for the remaining packets in the PDU set.

In some embodiments, the congestion level may be added to the PDU set descriptor or the PDU Set header along with, or instead of, the CE indication.

Some embodiments may leverage dependencies between PDU sets. Since scheduling is meant to happen on a PDU-set basis, CE indications can be provided on a per-PDU-set basis. Assuming the UE 104 needs to set only one bit in one PDU set, the bit may travel all the way through to the UPF 120, which sets the CE indications for all the remaining packets in the PDU set.

One option is to repeat the CE indication at least once per PDU set. For example, if congestion is detected for a traffic flow, each PDU set may be provided with a CE-set indication. These CE indications may be provided in any of the manners discussed above with respect to FIG. 3, for example. CE indications may need to be provided for each subsequent PDU set as long as the same condition applies. If the condition changes, for example, the congestion is cleared, the CE indications may be updated to reflect present congestion conditions. In some embodiments, an absence of a CE indication may be interpreted as a CE-clear indication.

In another option, a CE condition set for one PDU set may apply to one or more subsequent PDU sets. The indicated CE condition may persist until a different CE condition is indicated or a preconfigured number of PDU sets are transmitted/received. In this option, it may not be necessary to explicitly repeat the parameter in every PDU set. This option may be useful when a congestion condition is indicated through, for example, a dedicated control PDU. For example, a first dedicated control PDU may provide a CE-set indication and, when the congestion abates, a second dedicated control PDU may sent with a CE-clear indication.

In some embodiments, CE indication provided with a first PDU set may attach to one or more other PDU sets that are associated with (e.g., depend on) the first PDU set. Consider, for example, a situation in which dependencies between different PDU sets exist. This may occur in, for example, a group of pictures (GOP) or an I frame followed by a P frame. A CE indication provided with a first PDU set having the I frame may carry over to a second PDU set having a P frame that depends on the I frame.

As XR traffic is “quasi-periodic” and happens in bursts with PDU sets of varying data size, the detection of a congestion condition for XR traffic flows may follow a slightly different pattern than on other traffic flows. For example, delays may be introduced through pre-encoding, encoding of slices, packet transmission, etc. Further, if a data burst varies and becomes large while the grant size (or bandwidth available at an intermediate node) remains unchanged, then queues will become longer. In light of the unique characteristics associated with XR traffic, various options for XR aware congestion detection are provided below.

In a first option, congestion detection thresholds associated with XR traffic flows may be configured independently from other traffic flows. For example, a device may be configured with a first set of parameters that it may use to detect congestion in XR traffic flows and a second set of parameters it may use to detect congestion in non-XR traffic flows.

In a second option, congestion detection thresholds for XR traffic may be determined from a common congestion threshold configured to a device. For example, a UE may be configured with a first set of parameters that it is to use to detect congestion in non-XR traffic flows (e.g., for a PDU session, a DRB, or a PDCP, RLC, or MAC entity). The UE may then determine the second set of parameters that it is to use to detect congestion in XR traffic flows by applying a weighting factor to the first set of parameters. The weighting factor may help trigger congestion in XR traffic slightly sooner or slightly later as compared to other traffic flows. The weighting factor may be predetermined or configured by a network.

In a third option, an amount of jitter may be used as a basis for determining congestion with respect to XR traffic flow. A traffic flow with a high amount of jitter could amount to larger fluctuations in congestion conditions. For example, if a packet arrives extremely late (due to jitter), the sender may predict it is going to cause some backlog for some packets that are coming subsequently, because the sender may need to handle this late packet first before addressing others. Likewise, a receiver may declare congestion if a packet or a group of packets arrived very late, which may have repercussions for the traffic in the opposite direction, so a congestion event may be triggered there as well.

In a fourth option, a percentage of packets that are expected to be delivered within a packet delay budget (PDB) or PDU set delay budget (PSDB) in congested (or non-congested) scenarios may be defined. It may be expected that a certain percentage of PDU sets should not experience a delay exceeding 5G QoS identifier's (5QI's) (or QFI's) PSDB. If a device determines that a number of packets delivered within these constraints is less than the predetermined threshold, it may determine the XR traffic is experiencing congestion.

In a fifth option, congestion thresholds in the RAN 116 can be tuned based on guidance from the XR aware application 108 through assistance information. In some embodiments, the assistance information may include congestion levels or other properties or capabilities determined by the UE 104. The UE 104 may provide the RAN 116 this assistance information. The RAN 116 may then configure the congestion threshold that are used by the RAN 116 or the UE 104 based on this assistance information.

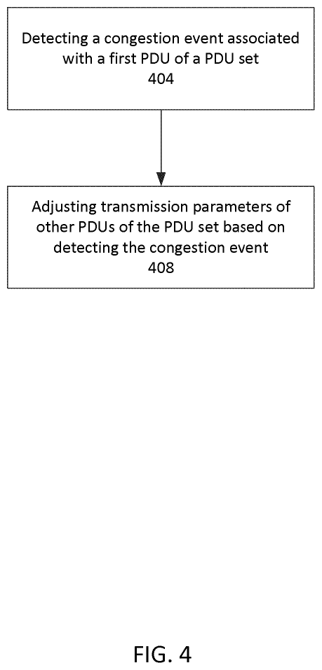

FIG. 4 illustrates an operation flow/algorithmic structure 400 in accordance with some embodiments. The operation flow/algorithmic structure 400 may be performed by a device such as the UE 104, a device of the RAN 116 or CN 118, UE 700, network node 800, or components thereof, for example, processing circuitry 704 or 804.

The operation flow/algorithmic structure 400 may include, at 404, detecting a congestion event associated with a first PDU of a PDU set. The PDU set may be part of a bitstream of data carrying XR traffic in accordance with some embodiments. The PDU set may include a set of application layer PDUs, IP PDUs, SDAP PDUs, PDCP PDUs, RLC PDUs, or MAC PDUs

In some embodiments, a congestion event may be detected by comparing operating states to various predetermined thresholds. The operating states may be associated with a state of a queue or buffer (e.g., percent filled, amount of data, etc.), a number of retransmissions, a number of acknowledgements, whether a packet was determined to be successfully transmitted with a period of time (e.g., based on a delay budget or discard timer), receipt or transmission of a packet within an expected period of time, a sojourn time, a round-trip time, a size of a gap in sequence numbers, QoS parameters, QoE parameters, etc.

The thresholds used to detect the congestion event may be common to different types of traffic flows or may be specific to XR traffic. If the thresholds are specific to XR traffic, they may be configured independent from common thresholds, or may be configured based on common thresholds using, for example, a weighting function. In some embodiments, XR-specific thresholds may include a jitter threshold. A congestion event may be detected if a level of jitter experienced by XR traffic is greater or less than the jitter threshold. In some embodiments, XR-specific thresholds may include a percentage of packets expected to be delivered within a delay budget.

In some embodiments, the congestion event may indicate that a traffic flow is experiencing congestion or the traffic flow is not experiencing congestion. In other embodiments, the congestion event may indicate that the traffic flow is experiencing a particular level of congestion.

The operation flow/algorithmic structure 400 may further include, at 408, adjusting transmission parameters of other PDUs of the PDU set based on detecting the congestion event. In some embodiments, the adjusting of the transmission parameters may include one or more of: increasing a priority level or importance of the PDU set; increasing a priority level of a logical channel of a data radio bearer or quality of service flow associated with the PDU set; enabling PDCP duplication for the PDU set; adjusting a radio resource allocation for the PDU set; allocating additional radio resources for the PDU set; or entering a survival time.

In some embodiments, the adjusted transmission parameters may include layer 1 parameters that include CG/SPS parameters, MCS, a number of repetitions, or transmit power.

In some embodiments, the adjusted transmission parameters may include layer 2 parameters that include, for example, LCH prioritization mapping rules or PDCP-to-RLC entity mapping.

In some embodiments, adjusting the transmission parameter may include changing the transmission parameter from a first setting to a second setting. The first/second settings may be associated with prioritizing transmission of high-priority PDU sets over low-priority PDU sets; dropping one or more PDU sets having a priority level below the threshold level; or applying a congestion policy defined by a network.

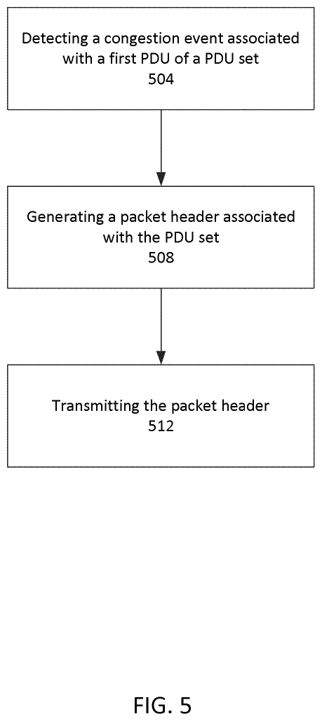

FIG. 5 illustrates an operation flow/algorithmic structure 500 in accordance with some embodiments. The operation flow/algorithmic structure 500 may be performed by a device such as the UE 104, a device of the RAN 116 or CN 118, UE 700, network node 800, or components thereof, for example, processing circuitry 704 or 804.

The operation flow/algorithmic structure 500 may include, at 504, detecting a congestion event associated with a first PDU of a PDU set. Detecting the congestion event may be similar to that described above with respect to FIG. 4 or elsewhere herein.

The operation flow/algorithmic structure 500 may include, at 508, generating a packet header associated with the PDU set. The packet header may be generated with a CE indication that indicates whether the traffic flow is experiencing congestion. Additionally/alternatively, the packet header may be generated with congestion level information to provide an indication of a level of congestion the traffic flows experiencing.

In some embodiments, the packet header may be a PDU set descriptor that is associated with a plurality of L2 SDUs of a PDU set. In other embodiments, the packet header may be a PDU set packet header that is associated with an individual L2 SDU of the PDU set.

The operation flow/algorithmic structure 500 may include, at 512, transmitting the packet header. The packet header may be sent with the bitstream of data that includes the PDU set.

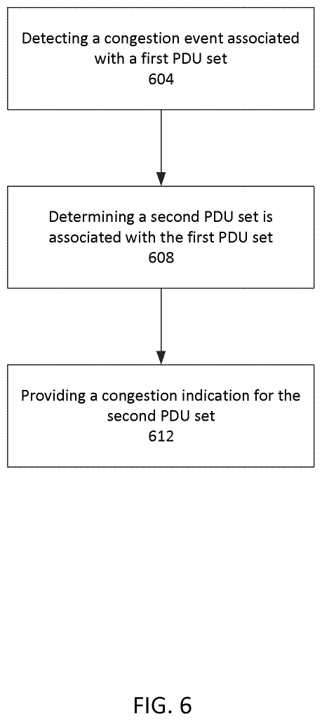

FIG. 6 illustrates an operation flow/algorithmic structure 600 in accordance with some embodiments. The operation flow/algorithmic structure 600 may be performed by a device such as the UE 104, a device of the RAN 116 or CN 118, UE 700, network node 800, or components thereof, for example, processing circuitry 704 or 804.

The operation flow/algorithmic structure 600 may include, at 604, detecting a congestion event associated with a first PDU set. Detecting the congestion event may be similar to that described above with respect to FIG. 4 or elsewhere herein.

The operation flow/algorithmic structure 600 may include, at 608, determining a second PDU set is associated with the first PDU set. In some embodiments, the second set may be associated with the first set based on a sequence of the two PDU sets. For example, if the second set follows the first set (either immediately after, within a predetermined number of PDU sets, or without a predefined event occurring (e.g., a change in congestion condition)) it may be considered associated therewith. In other embodiments, the association may be based on a dependency relationship between the two PDU sets. For example, if the second PDU set depends on the first PDU set, it may be considered associated there with. This may occur if, for example, the first PDU set provides an I frame and the second PDU set provides a P frame that depends on the I frame.

The operation flow/algorithmic structure 600 may include, at 612, providing a congestion indication for the second PDU set. The congestion indication for the second PDU set may be based on the association between the first and second PDU sets and the detection of the congestion event with respect to the first PDU set.

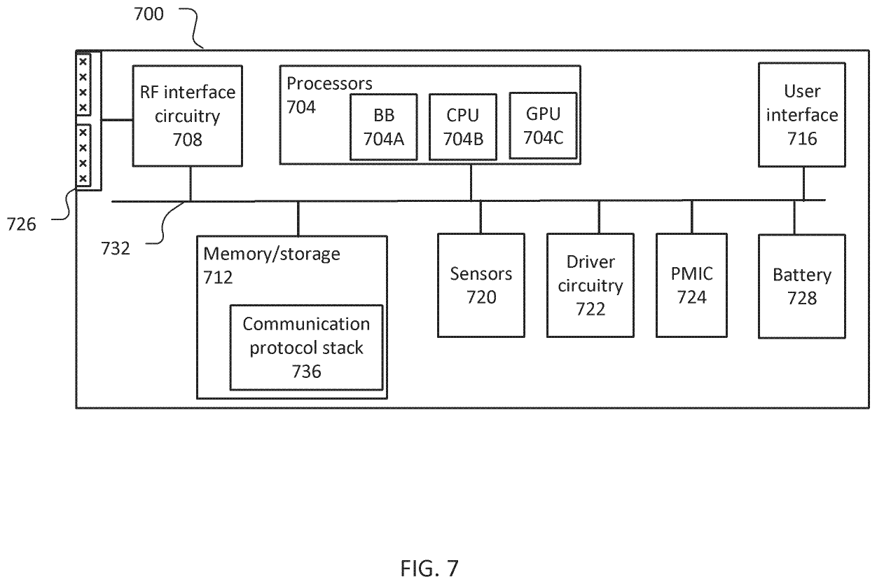

FIG. 7 illustrates a UE 700 in accordance with some embodiments. The UE 700 may be similar to and substantially interchangeable with UE 104 of FIG. 1.

The UE 700 may be any mobile or non-mobile computing device, such as, for example, a mobile phone, computer, tablet, XR device, glasses, industrial wireless sensor (for example, microphone, carbon dioxide sensor, pressure sensor, humidity sensor, thermometer, motion sensor, accelerometer, laser scanner, fluid level sensor, inventory sensor, electric voltage/current meter, or actuator), video surveillance/monitoring device (for example, camera or video camera), wearable device (for example, a smart watch), or Internet-of-things device.

The UE 700 may include processors 704, RF interface circuitry 708, memory/storage 712, user interface 716, sensors 720, driver circuitry 722, power management integrated circuit (PMIC) 724, antenna structure 726, and battery 728. The components of the UE 700 may be implemented as integrated circuits (ICs), portions thereof, discrete electronic devices, or other modules, logic, hardware, software, firmware, or a combination thereof. The block diagram of FIG. 7 is intended to show a high-level view of some of the components of the UE 700. However, some of the components shown may be omitted, additional components may be present, and different arrangement of the components shown may occur in other implementations.

The components of the UE 700 may be coupled with various other components over one or more interconnects 732, which may represent any type of interface, input/output, bus (local, system, or expansion), transmission line, trace, or optical connection that allows various circuit components (on common or different chips or chipsets) to interact with one another.

The processors 704 may include processor circuitry such as, for example, baseband processor circuitry (BB) 704A, central processor unit circuitry (CPU) 704B, and graphics processor unit circuitry (GPU) 704C. The processors 704 may include any type of circuitry or processor circuitry that executes or otherwise operates computer-executable instructions, such as program code, software modules, or functional processes from memory/storage 712 to cause the UE 700 to perform operations as described herein.

In some embodiments, the baseband processor circuitry 704A may access a communication protocol stack 736 in the memory/storage 712 to communicate over a 3GPP compatible network. In general, the baseband processor circuitry 704A may access the communication protocol stack 736 to: perform user plane functions at a PHY layer, MAC layer, RLC sublayer, PDCP sublayer, SDAP sublayer, and upper layer; and perform control plane functions at a PHY layer, MAC layer, RLC sublayer, PDCP sublayer, RRC layer, and a NAS layer. In some embodiments, the PHY layer operations may additionally/alternatively be performed by the components of the RF interface circuitry 708.

The baseband processor circuitry 704A may generate or process baseband signals or waveforms that carry information in 3GPP-compatible networks. In some embodiments, the waveforms for NR may be based cyclic prefix OFDM (CP-OFDM) in the uplink or downlink, and discrete Fourier transform spread OFDM (DFT-S-OFDM) in the uplink.

The memory/storage 712 may include one or more non-transitory, computer-readable media that includes instructions (for example, communication protocol stack 736) that may be executed by one or more of the processors 704 to cause the UE 700 to perform various operations described herein. The memory/storage 712 include any type of volatile or non-volatile memory that may be distributed throughout the UE 700. In some embodiments, some of the memory/storage 712 may be located on the processors 704 themselves (for example, L1 and L2 cache), while other memory/storage 712 is external to the processors 704 but accessible thereto via a memory interface. The memory/storage 712 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 708 may include transceiver circuitry and radio frequency front module (RFEM) that allows the UE 700 to communicate with other devices over a radio access network. The RF interface circuitry 708 may include various elements arranged in transmit or receive paths. These elements may include, for example, switches, mixers, amplifiers, filters, synthesizer circuitry, and control circuitry.

In the receive path, the RFEM may receive a radiated signal from an air interface via antenna structure 726 and proceed to filter and amplify (with a low-noise amplifier) the signal. The signal may be provided to a receiver of the transceiver that down-converts the RF signal into a baseband signal that is provided to the baseband processor of the processors 704.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 726.

In various embodiments, the RF interface circuitry 708 may be configured to transmit/receive signals in a manner compatible with NR access technologies.

The antenna 726 may include antenna elements to convert electrical signals into radio waves to travel through the air and to convert received radio waves into electrical signals. The antenna elements may be arranged into one or more antenna panels. The antenna 726 may have antenna panels that are omnidirectional, directional, or a combination thereof to enable beamforming and multiple input, multiple output communications. The antenna 726 may include microstrip antennas, printed antennas fabricated on the surface of one or more printed circuit boards, patch antennas, or phased array antennas. The antenna 726 may have one or more panels designed for specific frequency bands including bands in FR1 or FR2.

The user interface circuitry 716 includes various input/output (I/O) devices designed to enable user interaction with the UE 700. The user interface 716 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, and projectors), with the output of characters, graphics, multimedia objects, and the like being generated or produced from the operation of the UE 700.

The sensors 720 may include devices, modules, or subsystems whose purpose is to detect events or changes in its environment and send the information (sensor data) about the detected events to some other device, module, or subsystem. Examples of such sensors include inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; and microphones or other like audio capture devices.

The driver circuitry 722 may include software and hardware elements that operate to control particular devices that are embedded in the UE 700, attached to the UE 700, or otherwise communicatively coupled with the UE 700. The driver circuitry 722 may include individual drivers allowing other components to interact with or control various I/O devices that may be present within, or connected to, the UE 700. For example, the driver circuitry 712 may include circuitry to facilitate coupling of a UICC (for example, UICC 78) to the UE 700. For additional examples, driver circuitry 722 may include a display driver to control and allow access to a display device, a touchscreen driver to control and allow access to a touchscreen interface, sensor drivers to obtain sensor readings of sensor circuitry 720 and control and allow access to sensor circuitry 720, drivers to obtain actuator positions of electro-mechanic components or control and allow access to the electro-mechanic components, a camera driver to control and allow access to an embedded image capture device, audio drivers to control and allow access to one or more audio devices.

The PMIC 724 may manage power provided to various components of the UE 700. In particular, with respect to the processors 704, the PMIC 724 may control power-source selection, voltage scaling, battery charging, or DC-to-DC conversion.

In some embodiments, the PMIC 724 may control, or otherwise be part of, various power saving mechanisms of the UE 700 including DRX as discussed herein.

A battery 728 may power the UE 700, although in some examples the UE 700 may be mounted deployed in a fixed location, and may have a power supply coupled to an electrical grid. The battery 728 may be a lithium ion battery, a metal-air battery, such as a zinc-air battery, an aluminum-air battery, a lithium-air battery, and the like. In some implementations, such as in vehicle-based applications, the battery 728 may be a typical lead-acid automotive battery.

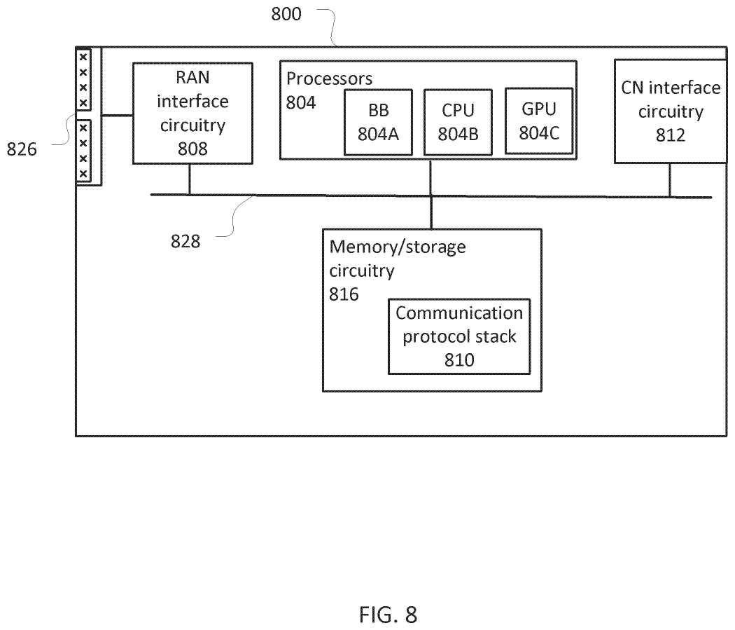

FIG. 8 illustrates a network node 800 in accordance with some embodiments. The network node 800 may be a device of the RAN 116 or the CN 118.

The network node 800 may include processors 804, RF interface circuitry 808 (if implemented as an access node), core network (CN) interface circuitry 812, memory/storage circuitry 816, and antenna structure 826.

The components of the network node 800 may be coupled with various other components over one or more interconnects 828.

The processors 804, RF interface circuitry 808, memory/storage circuitry 816 (including communication protocol stack 810), antenna structure 826, and interconnects 828 may be similar to like-named elements shown and described with respect to FIG. 7.

The CN interface circuitry 812 may provide connectivity to a core network, for example, a 5th Generation Core network (5GC) using a 5GC-compatible network interface protocol such as carrier Ethernet protocols, or some other suitable protocol. Network connectivity may be provided to/from the network node 800 via a fiber optic or wireless backhaul. The CN interface circuitry 812 may include one or more dedicated processors or FPGAs to communicate using one or more of the aforementioned protocols. In some implementations, the CN interface circuitry 812 may include multiple controllers to provide connectivity to other networks using the same or different protocols.

In some embodiments, the network node 800 may be coupled with transmit receive points (TRPs) using the antenna structure 826, CN interface circuitry, or other interface circuitry.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more aspects, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

In the following sections, further exemplary aspects are provided.

Example 1 includes a method of operating a device, the method comprising: detecting a congestion event associated with a first protocol data unit (PDU) of a PDU set; and adjusting transmission parameters of other PDUs of the PDU set based on detecting the congestion event.

Example 2 includes the method of example 1 or some other example herein, wherein the PDU set is a set of application layer PDUs, Internet protocol (IP) PDUs, service data adaptation protocol (SDAP) PDUs, packet data convergence protocol (PDCP) PDUs, radio link control (RLC) PDUs, or media access control (MAC) PDUs.

Example 3 includes method of example 1 or some other example herein, wherein adjusting transmission parameters comprises: increasing a priority level or importance of the PDU set.

Example 4 includes the method of example 1 or some other example herein, wherein adjusting transmission parameters comprises: increasing a priority level of a logical channel of a data radio bearer or quality of service flow associated with the PDU set; enabling packet data convergence protocol (PDCP) duplication for the PDU set; adjusting a radio resource allocation for the PDU set; allocating additional radio resources for the PDU set; or entering a survival time.

Example 5 includes a method of example 4 some other example herein, wherein the transmission parameters comprise layer 2 parameters that include logical channel prioritization mapping rules; or packet data convergence protocol (PDCP) to radio link control (RLC) entity mapping.

Example 6 includes a method of example 1 or some other example herein, wherein the transmission parameters comprise layer 1 parameters that include configured grant or semi-persistent scheduling parameter, modulation and coding scheme, number of repetitions, or transmit power.

Example 7 includes the method of example 1 or some other example herein, wherein the congestion event is a first congestion event that indicates the PDU set is experiencing congestion, adjusting the transmission parameter comprises changing the transmission parameter from a first setting to a second setting and the method further comprises: transmitting PDU sets based on the second setting until detection of a second congestion event that indicates another PDU set is not experiencing congestion.

Example 8 includes method of example 7 or some other example herein, wherein operation according to the second setting comprises: prioritizing transmission of high-priority PDU sets over low priority PDU sets; dropping one or more PDU sets having a priority level below a threshold level; or applying a congestion policy defined by a network.

Example 9 includes the method of example 1 or some other example herein, further comprising: providing assistance information to a radio access network that includes an indication of a congestion level.

Example 10 includes a method of example 9 or some other example herein, wherein the congestion level provides an indication of a predetermined level of congestion or a percentage of packets or PDU sets that have experience congestion over a period of time.

Example 11 includes the method of example 1 or some other example herein, wherein the PDU set is associated with an extended reality (XR) traffic flow and said detecting the congestion event comprises: identifying a congestion detection threshold corresponding to the XR traffic flow; and detecting the congestion event based on the congestion detection threshold.

Example 12 includes the method of example 11 or some other example herein, wherein the congestion detection threshold is a first congestion detection threshold and said identifying the first congestion detection threshold comprises: identifying a second congestion detection threshold corresponding to non-XR traffic; and applying a weighting factor to the second congestion detection threshold to obtain the first congestion detection threshold.

Example 13 includes the method of example 11 or some other example herein, wherein the congestion detection threshold comprises a jitter threshold and the method further comprises: determining a level of jitter experienced by the XR traffic is greater than the jitter threshold; and detecting the congestion event based on said determining the level of jitter experienced by the XR traffic is greater than the jitter threshold.

Example 14 includes the method of example 11 or some other example herein, wherein the congestion detection threshold comprises a percentage of packets expected to be delivered within a delay budget.

Example 15 includes the method of example 11 or some other example herein, wherein the congestion detection threshold is based on user equipment (UE) assistance information.

Example 16 includes a method comprising: detecting a congestion event associated with a protocol data unit (PDU) set; generating a packet header associated with the PDU set, the packet header to include one or more bits set to provide a congestion experienced (CE) indication based on said detecting the congestion event; and transmitting the packet header.

Example 17 includes the method of example 16 or some other example herein, wherein the one or more bits in the packet header are in a common parameter field that applies to all packets of the PDU set.

Example 18 includes the method of example 16 or some other example herein, wherein the one or more bits in the packet header are in a packet-specific field that applies to a packet having the packet header and the method further comprises: generating a packet header in each packet of the PDU set to include the one or more bits set to provide the CE indication.

Example 19 includes the method of example 16 or some other example herein, wherein the PDU set is associated with an extended reality (XR) traffic flow and said detecting the congestion event comprises: identifying a congestion detection threshold corresponding to the XR traffic flow; and detecting the congestion event based on the congestion detection threshold.

Example 20 includes a method comprising: detecting a congestion event associated with a first protocol data unit (PDU) set; determining an association between a second PDU and the first PDU set; and providing a congestion indication for the second PDU set based on detecting the congestion event and determining the second PDU set is associated with the first PDU set.

Example 21 includes the method of example 20 or some other example herein, wherein the association is based on the second PDU set immediately following the first PDU set.

Example 22 includes the method of example 20 or some other example herein, wherein the association is a dependency association.

Example 23 includes the method of example 22 or some other example herein, wherein the first PDU set is associated with an intra-coded picture (I) frame and the second PDU set is associated with a predicted (P) frame that depends on the I frame.

Example 24 includes the method of example 20 or some other example herein, wherein the PDU set is associated with an extended reality (XR) traffic flow and said detecting the congestion event comprises: identifying a congestion detection threshold corresponding to the XR traffic flow; and detecting the congestion event based on the congestion detection threshold.

Another example may include one or more non-transitory computer-readable media comprising instructions to cause an electronic device, upon execution of the instructions by one or more processors of the electronic device, to perform one or more elements of a method described in or related to any of examples 1-24, or any other method or process described herein.

Another example may include an apparatus comprising logic, modules, or circuitry to perform one or more elements of a method described in or related to any of examples 1-24, or any other method or process described herein.

Another example may include a method, technique, or process as described in or related to any of examples 1-24, or portions or parts thereof.

Another example may include an apparatus comprising: one or more processors and one or more computer-readable media comprising instructions that, when executed by the one or more processors, cause the one or more processors to perform the method, techniques, or process as described in or related to any of examples 1-24, or portions thereof.

Another example include a signal as described in or related to any of examples 1-24, or portions or parts thereof.

Another example may include a datagram, information element, packet, frame, segment, PDU, or message as described in or related to any of examples 1-24, or portions or parts thereof, or otherwise described in the present disclosure.

Another example may include a signal encoded with data as described in or related to any of examples 1-24, or portions or parts thereof, or otherwise described in the present disclosure.

Another example may include a signal encoded with a datagram, IE, packet, frame, segment, PDU, or message as described in or related to any of examples 1-24, or portions or parts thereof, or otherwise described in the present disclosure.

Another example may include an electromagnetic signal carrying computer-readable instructions, wherein execution of the computer-readable instructions by one or more processors is to cause the one or more processors to perform the method, techniques, or process as described in or related to any of examples 1-24, or portions thereof.

Another example may include a computer program comprising instructions, wherein execution of the program by a processing element is to cause the processing element to carry out the method, techniques, or process as described in or related to any of examples 1-24, or portions thereof.

Another example may include a signal in a wireless network as shown and described herein.

Another example may include a method of communicating in a wireless network as shown and described herein.

Another example may include a system for providing wireless communication as shown and described herein.

Another example may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of aspects to the precise form disclosed. Modifications and variations are possible in light of the above teachings or may be acquired from practice of various aspects.

Although the aspects above have been described in considerable detail, numerous variations and modifications will become apparent to those skilled in the art once the above disclosure is fully appreciated. It is intended that the following claims be interpreted to embrace all such variations and modifications.

1.-24. (canceled)

25. A method comprising:
detecting a congestion event associated with a traffic flow; and
generating an assistance information message to include congestion information based on said detecting the congestion event, wherein the congestion information includes an indication of a congestion level; and
outputting the assistance information message for transmission to a device.

26. The method of claim 25, wherein the congestion level is a percentage of congestion level in an uplink or downlink.

27. The method of claim 25, wherein detecting the congestion event includes detecting a protocol data unit (PDU) of a PDU set experiences congestion and the method further comprises:
adjusting transmission parameters of other PDUs of the PDU set based on detecting the congestion event.

28. The method of claim 27, wherein the PDU set is a set of application layer PDUs, Internet protocol (IP) PDUs, service data adaptation protocol (SDAP) PDUs, packet data convergence protocol (PDCP) PDUs, radio link control (RLC) PDUs, or media access control (MAC) PDUs.

29. The method of claim 27, wherein adjusting transmission parameters comprises:
increasing a priority level or importance of the PDU set.

30. The method of claim 27, wherein adjusting transmission parameters comprises:
increasing a priority level of a logical channel of a data radio bearer or quality of service flow associated with the PDU set;
enabling packet data convergence protocol (PDCP) duplication for the PDU set;
adjusting a radio resource allocation for the PDU set;
allocating additional radio resources for the PDU set; or
entering a survival time.

31. The method of claim 27, wherein the transmission parameters comprise layer 1 parameters that include configured grant or semi-persistent scheduling parameter, modulation and coding scheme, number of repetitions, or transmit power.

32. The method of claim 27, wherein the congestion event is a first congestion event that indicates the PDU set is experiencing congestion, adjusting the transmission parameters comprises changing the transmission parameters from a first setting to a second setting and the method further comprises:
transmitting PDU sets based on the second setting until detection of a second congestion event that indicates another PDU set is not experiencing congestion.

33. The method of claim 32, wherein operation according to the second setting comprises: prioritizing transmission of high-priority PDU sets over low priority PDU sets; dropping one or more PDU sets having a priority level below a threshold level; or
applying a congestion policy defined by a network.

34. The method of claim 25, wherein the traffic flow is an extended reality (XR) traffic flow and said detecting the congestion event comprises:
identifying a congestion detection threshold corresponding to the XR traffic flow; and
detecting the congestion event based on the congestion detection threshold.

35. The method of claim 34, wherein the congestion detection threshold is a first congestion detection threshold and said identifying the first congestion detection threshold comprises:
identifying a second congestion detection threshold corresponding to non-XR traffic; and
applying a weighting factor to the second congestion detection threshold to obtain the first congestion detection threshold.

36. The method of claim 34, wherein the congestion detection threshold comprises a jitter threshold and the method further comprises:
determining a level of jitter experienced by the XR traffic is greater than the jitter threshold; and
detecting the congestion event based on said determining the level of jitter experienced by the XR traffic is greater than the jitter threshold.

37. The method of claim 34, wherein the congestion detection threshold comprises a percentage of packets expected to be delivered within a delay budget.

38. One or more non-transitory, computer-readable media having instructions that, when executed, cause processor circuitry to:
detect a congestion event associated with a protocol data unit (PDU) set;
generate a packet header associated with the PDU set, the packet header to include one or more bits set to provide a congestion experienced (CE) indication based on the congestion event; and
output the packet header for transmission.

39. The one or more non-transitory, computer-readable media of claim 38, wherein the one or more bits in the packet header are in a common parameter field that applies to all packets of the PDU set.

40. The one or more non-transitory, computer-readable media of claim 38, wherein the one or more bits in the packet header are in a packet-specific field that applies to a packet having the packet header and the instructions, when executed, further cause the processor circuitry to:
generate a packet header in each packet of the PDU set to include the one or more bits set to provide the CE indication.

41. The one or more non-transitory, computer-readable media of claim 38, wherein the PDU set is associated with an extended reality (XR) traffic flow and to detect the congestion event the processor circuitry is to:
identify a congestion detection threshold corresponding to the XR traffic flow; and
detect the congestion event based on the congestion detection threshold.

42. An apparatus comprising:
processor circuitry to:
detect a congestion event associated with a first protocol data unit (PDU) set;
determine an association between a second PDU and the first PDU set; and
provide a congestion indication for the second PDU set based on detecting the congestion event and determining the second PDU set is associated with the first PDU set; and
interface circuitry coupled with the processor circuitry to enable communication.

43. The apparatus of claim 42, wherein the association is a dependency association.

44. The apparatus of claim 42, wherein the PDU set is associated with an extended reality (XR) traffic flow and to detect the congestion event the processor circuitry is to:
identify a congestion detection threshold corresponding to the XR traffic flow; and
detect the congestion event based on the congestion detection threshold.
